(19) United States
(12) Patent Application Publication
(10) Pub. No.: US 2010/0072114 A1
(43) Pub. Date: Mar. 25, 2010

(54) METHOD AND DEVICE FOR SORTING CONTAINERS FOR RECYCLING PURPOSES

(76) Inventor: Gérard Briane, Saint Juery (FR)

Correspondence Address: JEROME D. JACKSON (JACKSON PATENT LAW OFFICE), 211 N. UNION STREET, SUITE 100, ALEXANDRIA, VA, 22314, US

(21) Appl. No.: 12/440,570

(22) PCT Filed: Sep. 9, 2007
(86) PCT No.: PCT/FR07/51899

§ 371 Date: May 22, 2009

(51) Int. Cl. B07C 5/00; B07C 5/16; B07C 5/342; G01J 3/28; B26D 7/06

(52) U.S. Cl. 209/522; 356/326; 83/78

(57) ABSTRACT

The invention relates to a device (C) for sorting containers (B) of volumes and materials liable to different, notable in that it consists of a plurality of identification stations and/or of a plurality of packaging stations, and of a plurality of container support modules each consisting of a rod on which a container is fitted via its opening, causing the bottom of the container to come to rest on the top end of the rod, said support modules moving each container between and to the various work stations. The invention also relates to a sorting method corresponding to this device.

### FIELD OF APPLICATION OF THE INVENTION

The present invention relates to the field of sorting packaging and in particular to adaptations for recognising a maximum number of packaging types by the same device.

### DESCRIPTION OF THE PRIOR ART

There exist in the prior art dedicated sorting devices that, with a certain type of container, for example plastic bottles, are able to sort them for recycling purposes. Up until now, lines for sorting containers for recycling purposes start only after an initial identification or sorting for separating for example glass, plastic and metal. This initial identification is performed by the consumer or by the recycler.

There also exist in the prior art various means of recognising materials or shapes for making it possible to recognise the object examined.

Nevertheless, the applicant has found that existing lines could sort only a limited number of types of container.

Thus at the present time either the consumer/user separates his recyclable containers from the rest of his household waste and places them in a container dedicated to selected sorting, or the sorting takes place downstream.

At the present time the consumer does not have means providing, using a single collecting point, the sorting of all the containers or packaging that he contributes.

In addition, the applicant has found that the consumer, apart from moral satisfaction, did not have any financial advantage from his recycling efforts whereas some recycled materials have a not insignificant commercial value. This situation is in particular due to the current inability to offer an evaluation of all the containers brought for sorting by the consumer because of the heterogeneity of these containers or packagings.

### DESCRIPTION OF THE INVENTION

Starting from this state of affairs, the applicant has carried out research aimed at providing sorting of a plurality of heterogeneous containers and packaging, that is to say with different shapes and materials.

Another object of the invention is to propose a means for providing this sorting using a single entry point for all the containers.

Another object of the invention is to propose, by identifying the containers to be sorted, financial advantage to the person bringing the containers for sorting.

This research has thus led to the design of a device for sorting containers with volumes and materials liable to be different, remarkable in that it is formed by a plurality of identification stations, and/or

by a plurality of work stations, and

by a plurality of container support modules each formed by a rod on which a container is engaged through its opening, making the bottom of the container come into abutment on the top end of the rod, said support modules providing the movement of each container between and to the various stations.

This feature is particularly advantageous in that it proposes, on the same device, identification means associated with working means making the sorting more versatile and particularly profitable.

This versatility is possible by virtue of the type of support module used. Thus the support module takes the form of a rod on which the containers are engaged through their opening, which has the following advantages:
the consumer or handler is obliged to remove any stopper from the container in order to engage it on the rod,
the engagement movement, making it necessary to turn over the container, the opening of which is conventionally placed upwards, completes the emptying of the container,
by making the bottom of the container come into abutment on the top end of the rod, all the bottoms of the containers to be sorted are situated at the same height, which will make possible and facilitate certain identification and/or processing operations,
by judiciously using a rod making it possible to keep a sliding adjustment with all the types of containers, the container can have its position change along the rod, which will make possible and facilitate certain identification and/or processing operations.

To facilitate the implementation of the support module, each rod is associated with a plate serving as a guide means and a movement means.

In addition, each rod is associated with its plate in an articulated manner so as to pass from a position in which the container is carried by the rod to a position in which the container slides along the rod in order to be removed from it. Thus the use of the rod will also allow the automatic discharge of the container once identified and/or processed. For example, when the rod tilts downwards, the weight drives the container downwards.

According to another particularly advantageous feature facilitating the various operations, all the rods have the same dimensions and in particular the same length, thus having their ends at the same height. Likewise, the cross-section of the rod is chosen so that the engagement and disengagement of the containers are sliding. The container is therefore not held by the rod but rests on top while being supported by its bottom.

According to another particularly advantageous feature, said means of setting in movement is formed by a flexible link on which the support modules are disposed at regular intervals so that the movement of the containers takes place in step by step. This stepping movement will allow the placing of the containers on said rods in an appropriate fashion. In addition, it will prevent any overloading of the device in terms of quantity of sorted containers. In addition, it makes it possible to dispose the work and identification stations on the movement path of the containers so that all the operations can be performed on the different containers but in the same interval of time corresponding to the time passing from one step to another.

According to another feature, the device comprises, taken in combination or separate, the following identification means:
a station for visual recognition of the container by video means for determining the shape, colour and/or transparency,
a station identifying the composition of the container comprising a spectrometer,
a station for differentiating the metals using at least one inductive sensor,
a station for measuring the weight of the container.

The applicant has found that a sorting device having a configuration for identifying the containers incorporating the combination of stations mentioned above makes it possible to identify the majority of containers currently existing.

In order to facilitate the reprocessing of the containers able to be recycled, the applicant has imagined for the device, taken in combination or separate, the following processing stations:
a station for cutting the plastic collar, automatically removing said plastic collar, on containers identified as carrying one, the removal of which is an operation costly in terms of time,
a station for cutting the neck of the container, which removes all the coverings from said neck, which are very difficult to remove on a glass bottle,
at least one station cleaning the external surface of the container, which is formed by a subassembly brushing the external surface of the container, which will afford not only cleaning but also removal of labels or any paper covering.

The applicant has found that a sorting device having a container-processing configuration incorporating the combination of stations mentioned above makes it possible to make ready for recycling the majority of currently existing containers.

The device naturally comprises at least one discharge station that, once the container is identified and/or processed, separates the container with respect to its support rod. Thus, for each container identified and processed, this station makes the rod tilt in order to discharge the container to storage areas or to other movement, processing, etc. lines dedicated to the container identified.

In accordance with the objectives of the invention, a device incorporating in combination all the features described above is able to ensure the sorting of almost all existing containers. This versatility makes it possible to evaluate a financial reward to the person supplying the containers with respect to the value of the materials recycled.

Another object of the invention concerns a sorting method using all or part of the device of the invention described above. This method is remarkable in that it consists of causing to occur, on one and the same device, a plurality of identification steps on the container before providing processing operations and sorting operations strictly speaking, a plurality of container support modules providing the movement of each container between and to the various steps. This method and the device for implementing it are remarkable in that they associate identification operations, processing operations and sorting operations.

The fundamental concepts of the invention having just been disclosed above in their most elementary form, other details and features will emerge more clearly from a reading of the following description and with regard to the accompanying drawings, giving by way of non-limitative example an embodiment of a device and method in accordance with the invention.

### BRIEF DESCRIPTION OF THE DRAWINGS

FIG. 1 is a schematic drawing of an overall perspective view of an embodiment of a sorting device according to the invention,

FIG. 2 is an overall drawing in side view of the sorting device of FIG. 1,

FIGS. 3a, 3b, 3c and 3d are front and side views and views in the tilted position and in perspective of an embodiment according to the invention of a container support module,

FIG. 4 is a view in perspective of the receiving zone and viewing and spectrography stations of the sorting device of the invention,

FIG. 5 is a perspective view of the stations for viewing, spectrography and differentiation of metals,

FIG. 6 is a perspective view of the weighing station in the weighing position for a long container,

FIG. 7 is a perspective view of the weighing station in the weighing position for a short container,

FIG. 8 is a side view of the device going from the metal identification station to the discharge station,

FIG. 9 is a plan view of the station removing the collar in the standby position,

FIG. 10 is a plan view of the collar removal station in the active position,

FIG. 11 is a plan view of the neck cutting station in the standby position,

FIG. 12 is a plan view of the neck cutting station in the active position,

FIG. 13 is a perspective view of the cleaning station,

FIG. 14 is a side view in line with the movement of the containers from said cleaning station,

FIG. 15 is a perspective view of the discharge station.

### DESCRIPTION OF PREFERRED EMBODIMENTS

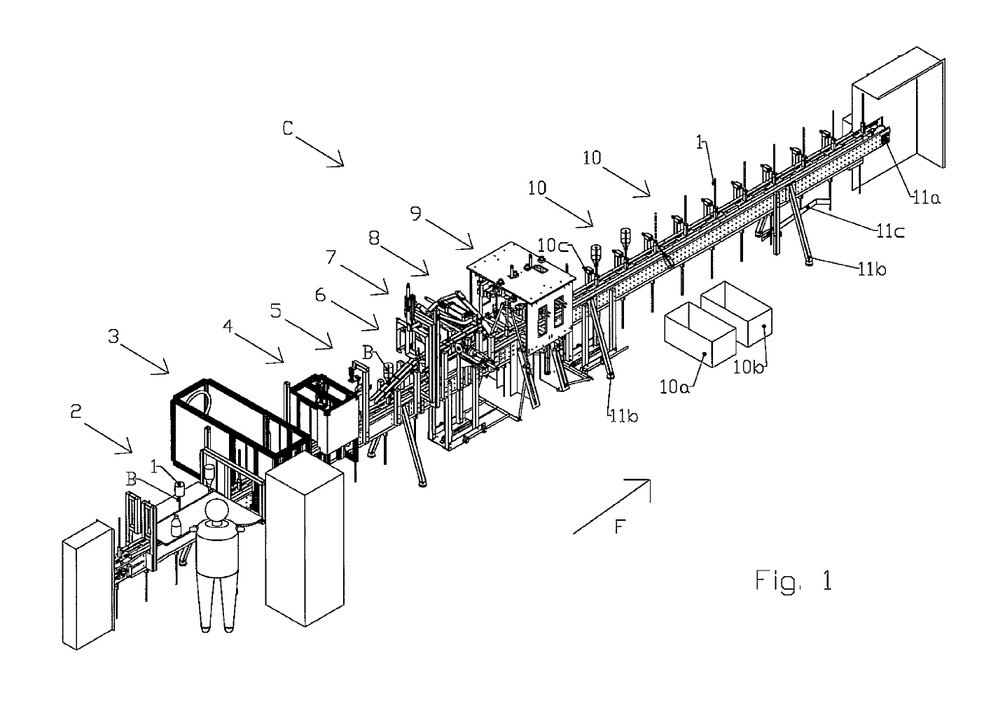

As illustrated on the drawing in FIG. 1, the identification and sorting line referenced C overall sets in motion the individual supports 1 for each container B in the direction of the arrow F and then returns said supports 1 in a movement in the opposite direction to that defined by the arrow F.

The line C passes said supports 1 and therefore the containers B installed thereon through various identification, processing and storage stations.

The line C starts with a zone 2 for receiving the containers B supplied by consumers or handlers, in which vacant individual supports 1 come to move and on which the consumer or handler turns over each container B to be recycled after having removed any stopper from it so that the container engages and bears on one of the supports, by means of its opening thus left clear.

According to the embodiment illustrated, said line C then makes the container carried by a support 1 pass through the following identification stations:
a first station 3 for visual recognition of the container B by video means determining the shape, colour and transparency,
a second station 4 identifying the composition of the container B comprising a spectrometer,
a third station 5 differentiating metals using at least one inductive sensor,
a fourth station 6 measuring the weight of the container.

According to the results of the identification made, the line C implements or not the following processing stations through which each container passes in a stepping movement:
a first station 7 cutting the plastic collar,
a second station 8 cutting the bottle neck,
a third station 9 brushing the external surface of the container.

Next comes the sorting or discharge operation proper where the containers identified and processed are discharged from the line C by means of at least one discharge station 10 dropping the container into recovery hoppers dedicated to the container identified.

The individual supports with the container removed then follow a return path to the reception station 2.

According to a preferred but not limitative embodiment, the setting in motion of the individual supports 1 is effected by an endless chain moved in a stepping movement corresponding to the distance P separating each support module 1. The identification and/or processing stations are thus disposed at this step P or in a multiple of this step P.

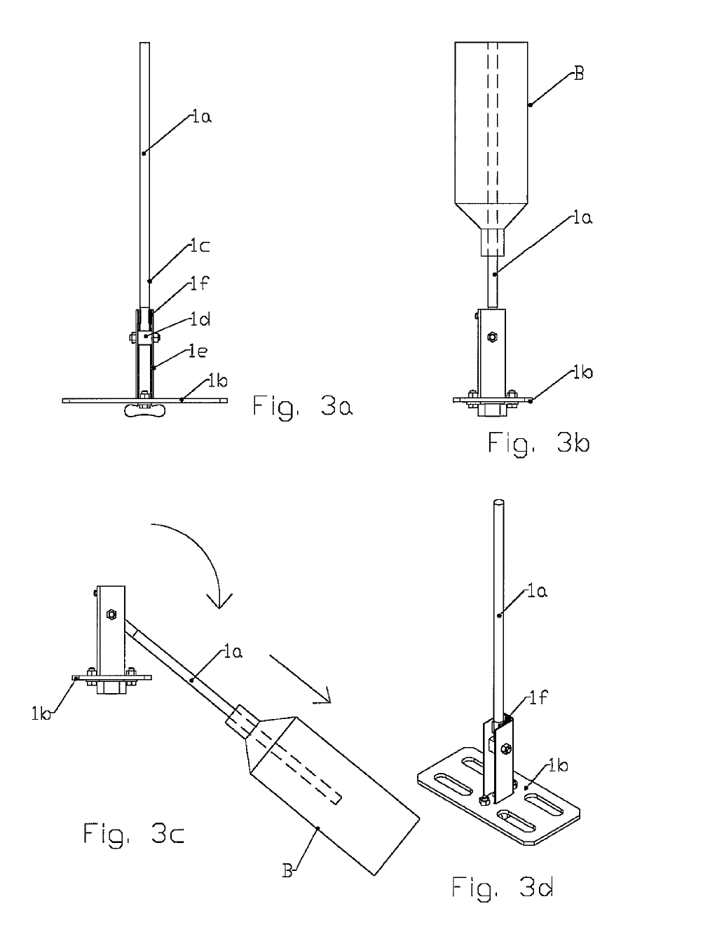

In accordance with the invention, a plurality of support modules 1 consisting of a rod on which the container B is engaged individually through its opening provide the movement of each container between and to the various identification and/or processing stations. These support modules are illustrated in more detail on the drawings in FIGS. 3a, 3b, 3c, 3d.

As illustrated, each rod 1a is disposed vertically and is associated with a plate 1b serving as a guide means and with a means of setting in movement that is formed by the chain, not illustrated. According to a preferred embodiment, this plate 1b consists of a flat profiled section, the corners of which have been bevelled. This bevelling will facilitate the introduction and movement of said plate 1b in the chassis 11 constituting the structure of the device C.

As illustrated, each rod 1a is associated in an articulated manner with its plate 1b so as to pass from a position in which the container B is carried by the rod as illustrated in FIG. 3b to a position where the container B slides along the rod as illustrated in FIG. 3c. The implementation of this tilting and the return to the initial position will be described a little later. The articulated base 1c of the rod 1a is connected and housed by a horizontal shaft 1d in a U-shaped profiled section 1e, disposed vertically on the plate 1b. Thus the rod can tilt only on the open side of the U. The other side of the U forming a mechanical stop on the bottom part 1c in order to lock the rotation movement of the rod 1a. As illustrated, this stop is associated with a means 1f of holding in a vertical position formed by a spring blade preformed so as to be housed in the U-shaped profile and to hold the rod 1a, by gripping it, in the vertical position despite the load afforded by the container B while allowing the tilting illustrated in FIG. 3c as soon as a force exceeding a predetermined threshold is applied to it.

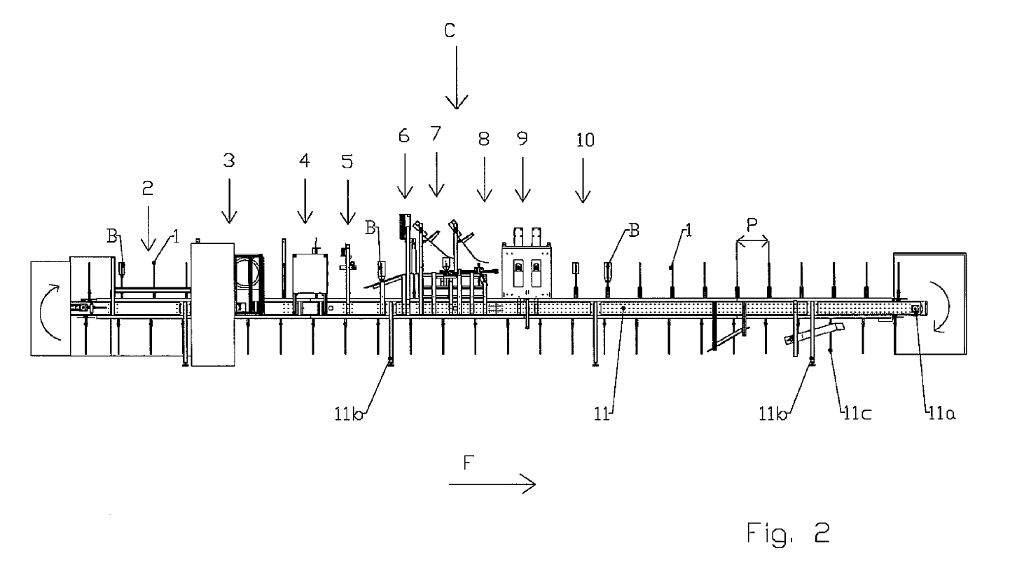

As illustrated on the drawing in FIGS. 1 and 2, said flexible link, not illustrated but formed according to a preferred embodiment, is set in motion and guided on a chassis 11 disposed so that the flexible link is continuous and the support modules 1, once arrived at one end of the chassis 11, can return to the other end.

To do this, the chassis 11 is associated with drive means and with means of guiding the chain such as the pinion 11a illustrated at the end of the chassis 11 in FIG. 2. Naturally other pinions are disposed along the chassis 11. These drive and guide means provide the continuous stepping movement of the chain, which makes the individual supports 1 pass from a vertical “head up” position above the chassis 11 in the direction of the arrow F to a vertical “head down” position below said chassis 11 in the direction opposite to the arrow F, that is to say when the support module 1 with its container B removed returns towards the loading position. This “head down” return is made possible by the fact that the chassis 11 and the movement path that it defines are disposed above the floor by virtue of a plurality of support legs 11b.

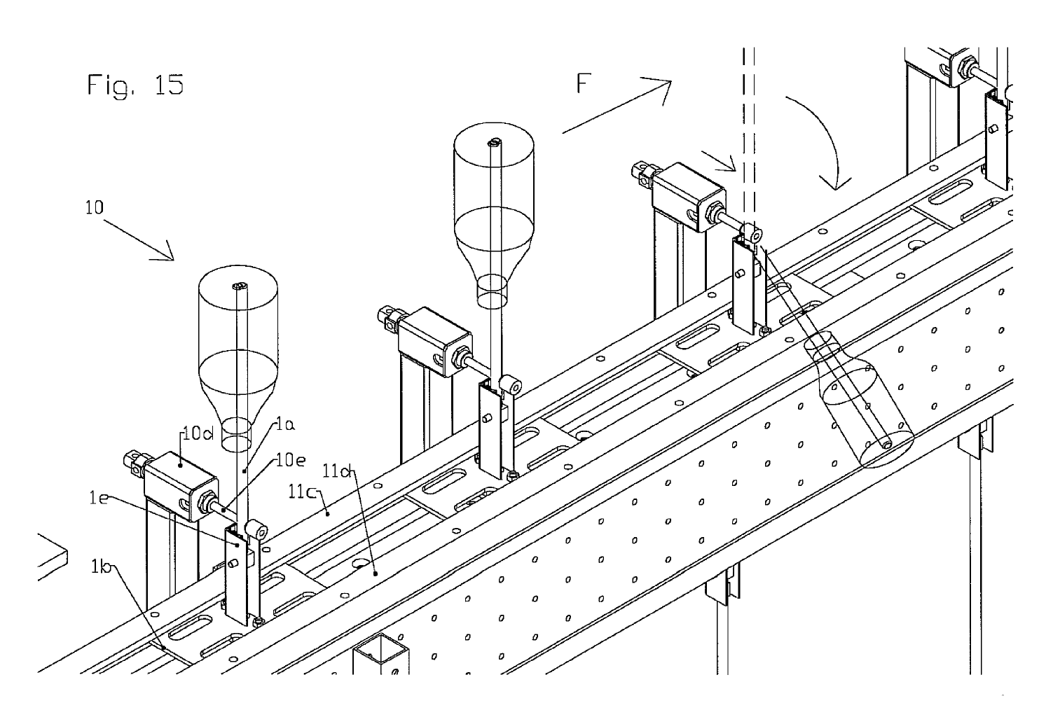

As illustrated in FIG. 15, said chassis 11 comprises, on its top part, a pair of horizontal rails 11c and 11d with which the longitudinal edges of the plate 1b cooperate so that each support module 1 is driven in translation by a connection between the bottom face of the plate 1b and the means of setting in movement, and guided in translation by virtue of the edges of said plate 1b.

The embodiment of the sorting device of the invention that has just been described in its most general aspect will now be described station by station. In this description the various advantages of the use of a rod as a transport means for the containers will in particular appear.

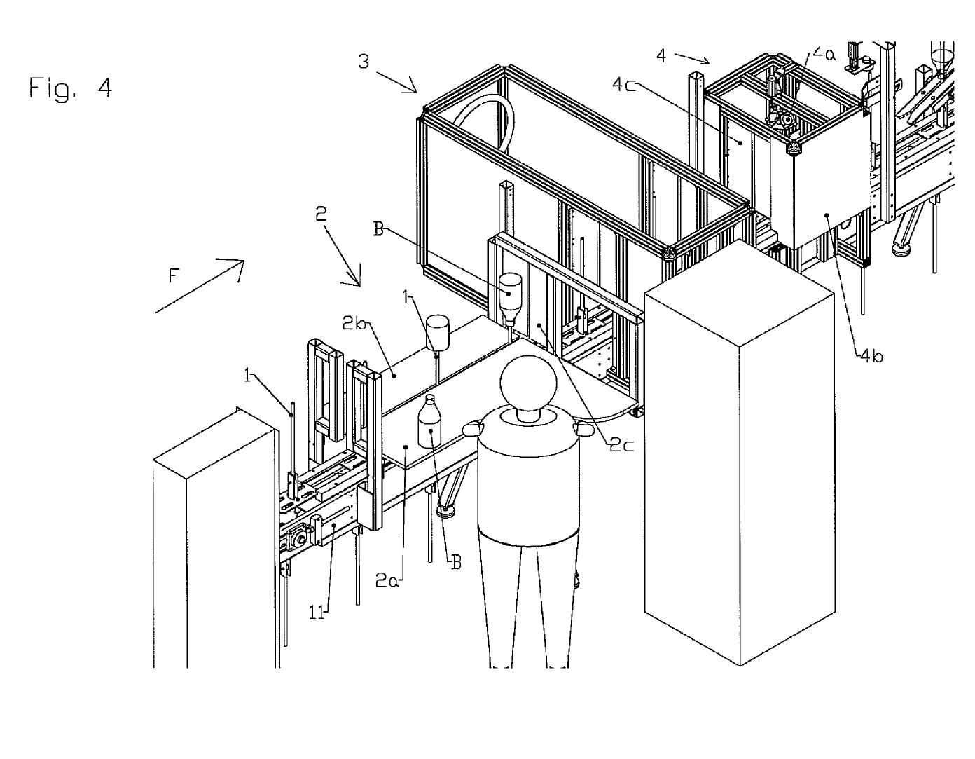

As illustrated on the drawings in FIGS. 1, 2 and 4, the zone 2 for receiving the containers B is situated at one end of the chassis 11 and therefore of the device C. This reception zone 2 consists of a partitioned space giving access directly to the support modules 1 circulating on the top part of the chassis 11. This reception zone is advantageously equipped with a work surface 2a on which the user will put the containers B before placing them on the rods 1a. Another work surface 2b closes any access to the kinematics of the chassis coming from the other side of the chassis 11 opposite the first work surface. The only thing that remains is the separation necessary for the passage of the rod 1a in the direction of movement. As illustrated, before passing into the first identification station, the container B will pass through a lobby consisting of two gates 2c, the edges of which, provided with brushes, perform a first cleaning of the container B. According to the embodiment illustrated, the reception zone 2 is sized so that three support modules 1 can be accessible therein.

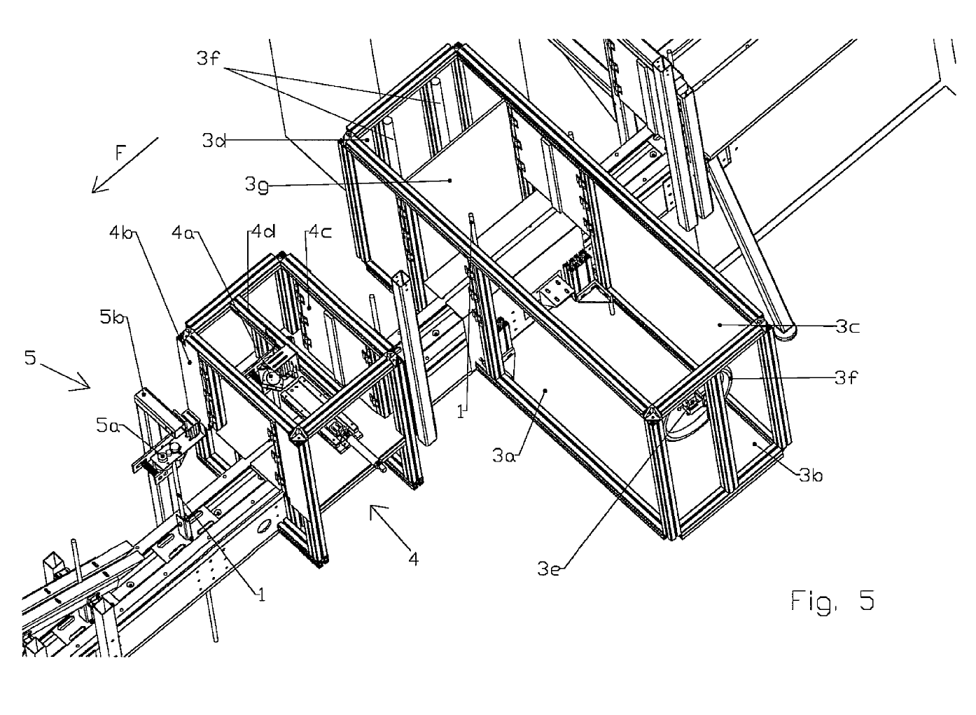

As illustrated on the drawing in FIG. 5, the station 3 for visual recognition of the container B is formed by a closed chamber fixed to the chassis 11 by four panels 3a, 3b, 3c and 3d, two of which are provided with openings for passage of the containers on their support module 1. The chamber is sized so that a single container can be contained therein, that is to say its width is less than the step separating two support modules 1 from each other. As illustrated, a video means 3e provides the shot that will be analysed in order to determine the shape, colour and transparency of the container B. The chamber makes it possible to always keep the same visual capture conditions whatever the container. Illumination 3f associated with a panel 3g serves as a background for the shooting completing this station. The image is then processed by computer software designed for this purpose. According to a particularly advantageous feature, the sorting method is remarkable in that it consists of visually locating the presence of the rod 1a in the container B in order to determine the transparency of said container. Thus the use of a rod supporting the container by being introduced into its internal volume is judiciously exploited to allow identification of transparency by video means. In addition, as the container B is always in abutment by virtue of its bottom on the top end of the rod 1a, the visual capture field comprises at least one well established limit.

As illustrated on the drawings in FIGS. 1, 2, 4 and 5, the second station 4 that identifies the composition of the container B is equipped with a spectrometer 4a associated with a chamber 4b that, as with the visual recognition station, makes it possible to limit the environment subjected to identification. The spectrometer 4a will differentiate between the plastics and separate the plastics from other materials such as cardboard or metal. As with the visual identification station 3, the entry to the chamber 4b is controlled by the automatic-return leaves of a gate 4c. This spectrometer 4a is fixed to a beam 4d positioning it above the movement path of the containers B for analysis of the bottom of the latter. This is because, by virtue of the use of an identical rod 1a for all the support modules 1, the bottoms of all the containers are positioned at the same height, which avoids managing the adapted positioning of the identification means for each container.

This feature is also used for the following station 5, the function of which, as illustrated on the drawings in FIGS. 1, 2, 4 and 5, is to differentiate the metals from each other using at least one inductive sensor 5a. This inductive sensor 5a is advantageously positioned at a fixed height by means of a bracket 5b. This station will make it possible in particular to locate aluminium.

The following station 6 requires specific implementation since, in order to measure the weight of the containers B, it is necessary for the latter not to be in abutment on the rod 1a which, up until then, has advantageously supported and especially positioned them. The latter station is necessary to complete the identification of the containers B to be sorted but also to assess the weight of the recyclable material brought by the user/consumer.

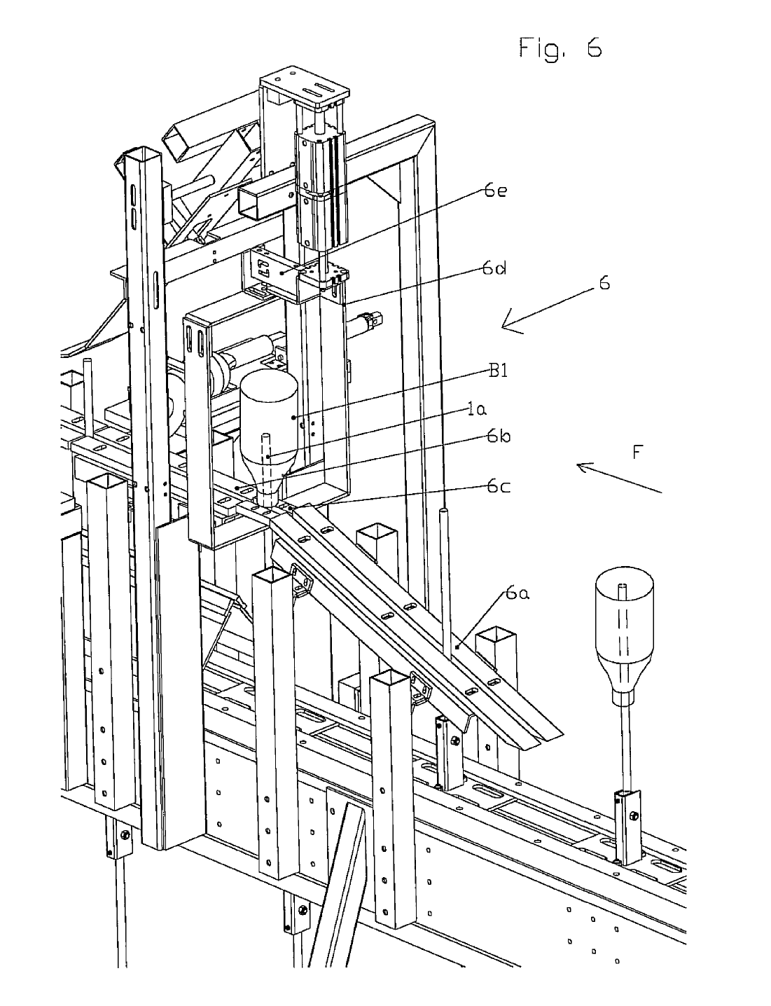

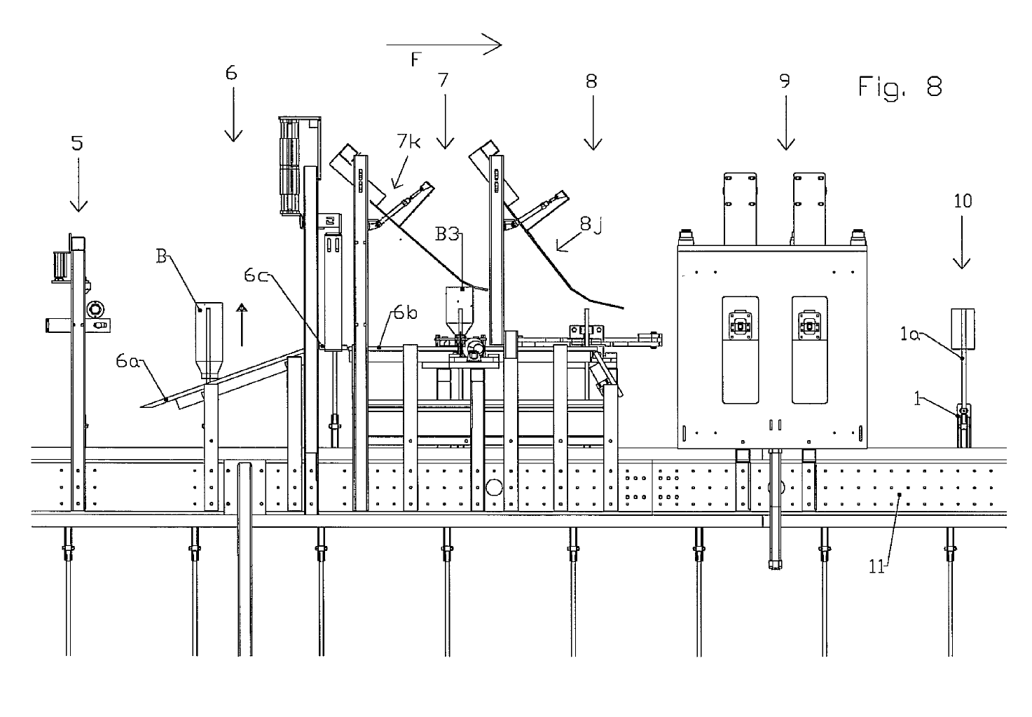

To perform this function, the applicant has imagined a specific configuration described below. In accordance with the invention and according to the embodiment illustrated in FIGS. 1, 2, 6, 7 and 8, the weighing station 6 comprises, disposed in front of the position where the container is weighed, an ascending ramp 6a disposed on each side of the movement path of the support modules 1 so as to allow only the diameter of the rod 1a to pass so that, during the translation movement of the support module 1 driven by the flexible link, the container B comes into abutment on the ramp and performs an upward translation movement. This ramp, as illustrated in FIG. 8, prevents the majority of the containers B remaining in abutment on the rod 1a. This ramp, by virtue of the progressive abutment that it effects on the top end of the containers (which is situated at the bottom since the containers are positioned turned over on their rod), brings the top end of the majority of the containers to the same height, preventing the bottom of these being in contact with the top end of the rod 1a. Thus, as illustrated on the drawing in FIG. 6, the movement of the support module 1 and the inclination of the ramp 6a bring the top end of the container B1 level with an upper horizontal ramp 6b, a section 6c of which is independent of the rest of the ramp. The support module 1 stops so that the container B1 is positioned on this ramp portion 6c, which is advantageously connected to a bracket 6d secured to a means of measuring the weight 6e or scales.

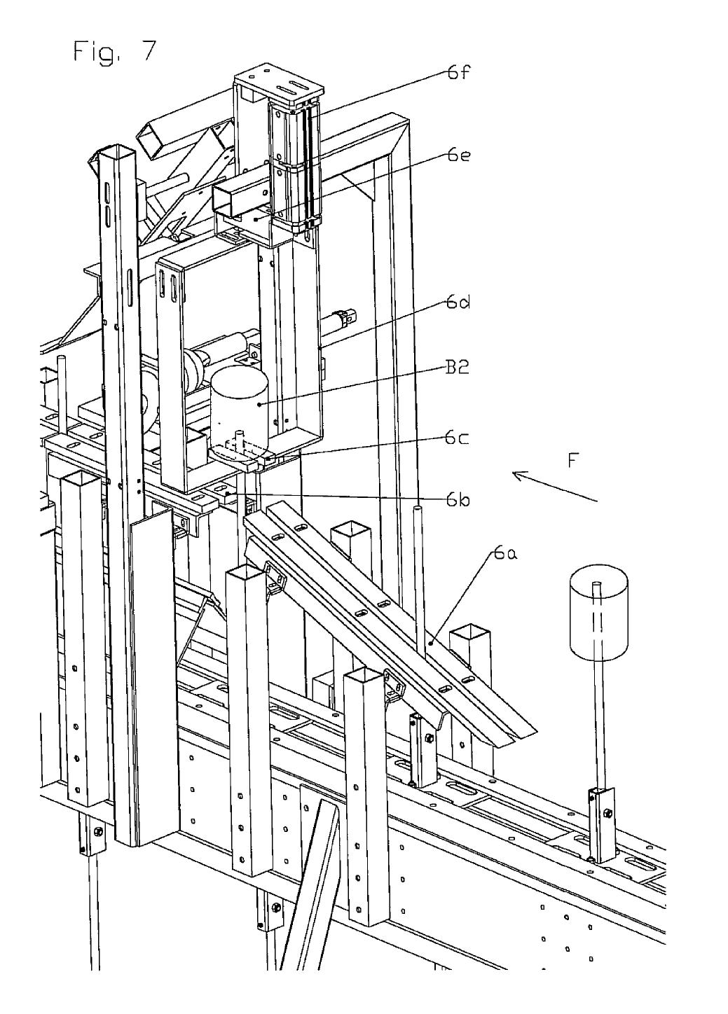

Nevertheless, containers of low height such as those illustrated in FIG. 7 and referenced B2 are liable to remain in abutment on the rod 1a without coming into contact with the inclined ramp 6a, the upper ramp 6b and the ramp section 6c. To mitigate this drawback, the bracket 6d supporting the ramp portion 6c is advantageously mounted mobile and moved in translation by means of a ram 6f. Thus, when no weight is detected in the low position of the bracket 6d, the latter is moved by a translation movement upwards so that the measurement of the weight carried out by the scales 6e is not interfered with by the abutment of the rod 1a.

Naturally, so that the setting in translation movement along the device C is preserved, the upper ramp 6b or even the top extreme position of the bracket does not disengage the container from the rod with which it is associated.

As illustrated on the drawing in FIG. 8, the levelling of the top end of the container B will advantageously be used by the following stations that process this part of the container B. Thus the usefulness of the ramp 6a, the prime function of which is to disconnect the bottom of the container from the abutment formed by the top end of the rod, is also to take as a reference not the bottom of the container but its top open end that is situated at the bottom since the container is positioned turned over on the rod. These inclined 6a and upper 6b ramps can therefore be associated in combination or not with stations other than the weighing station.

Each identification station has performed a measurement or a taking of information for each container. This information has been transmitted to supervising software, which can now identify the container and is able to sort it and discharge it to hoppers or related lines dedicated to its material, shape, etc. At this stage, it is also possible to transmit to the user/consumer the information on the financial reward related to the value of the materials of the containers that are recycled.

Nevertheless, in order to facilitate the recycling operations, the applicant has advantageously associated in this embodiment and in accordance with one feature of the invention, work stations in order to pre-process, before sorting, the containers identified as being able to be pre-processed.

As illustrated on the drawings in FIGS. 1, 2, 8, 9 and 10, the station for removing the plastic collar 7, as its name indicates, is intended for removing the plastic collar (not illustrated) conventionally equipping the necks of plastic bottles and the function of which is to hold the stopper in position when the bottle is not yet open. As this collar is conventionally made from a material different from that of the bottle, it is particularly advantageous to separate them before sorting. The solution proposed by the applicant for removing this collar is to provide the cutting of the latter so that it is no longer fixed to the neck of the container.

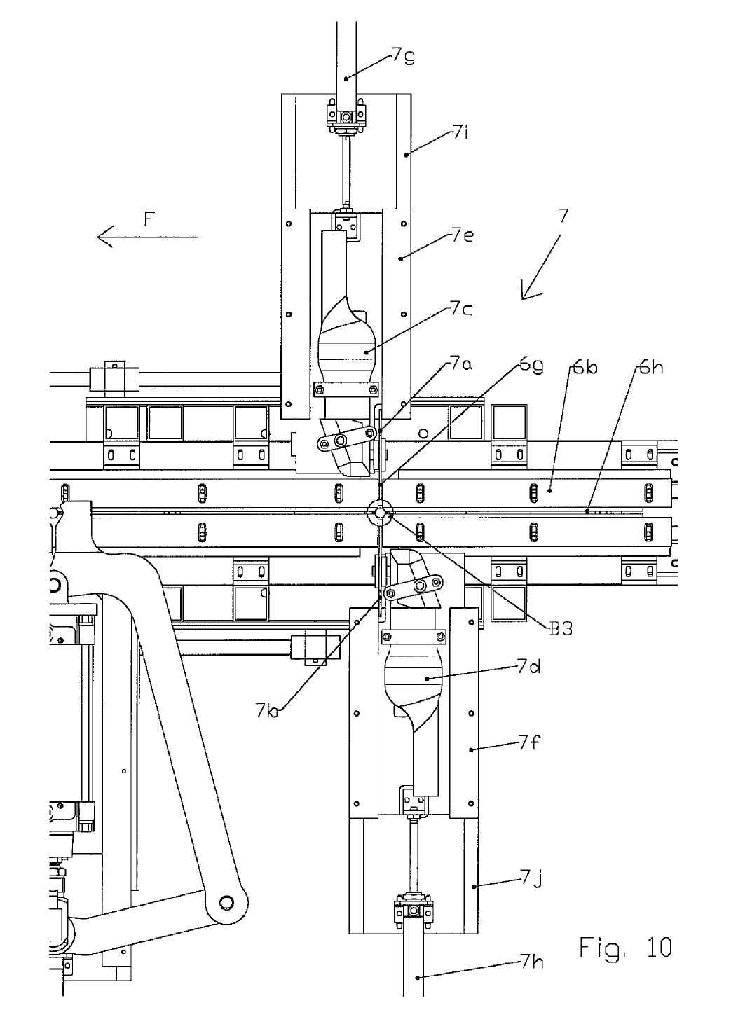

According to the embodiment illustrated and in accordance with the invention, the station cutting the collar 7 is formed by the blade of at least one saw that will come to be applied vertically to the neck and on a sufficient travel to cut said collar. According to a preferred embodiment, the cutting station implements two independent circular saw blades 7a and 7b turning in the same vertical plane and providing a translational travel towards the neck B3 of the bottle as illustrated on the drawing in FIG. 10. Advantageously, each blade 7a and 7b is moved by a motor 7c and 7d each secured to a movable carriage 7e and 7f guiding them in translation along an axis perpendicular to the movement axis of the containers B in the direction of the arrow F. The translation movement is provided by rams 7g and 7h fixed to tables 7i and 7j on which the carriages 7e and 7f slide in translation, each carrying a motor 7c and 7d driving a saw 7a and 7b.

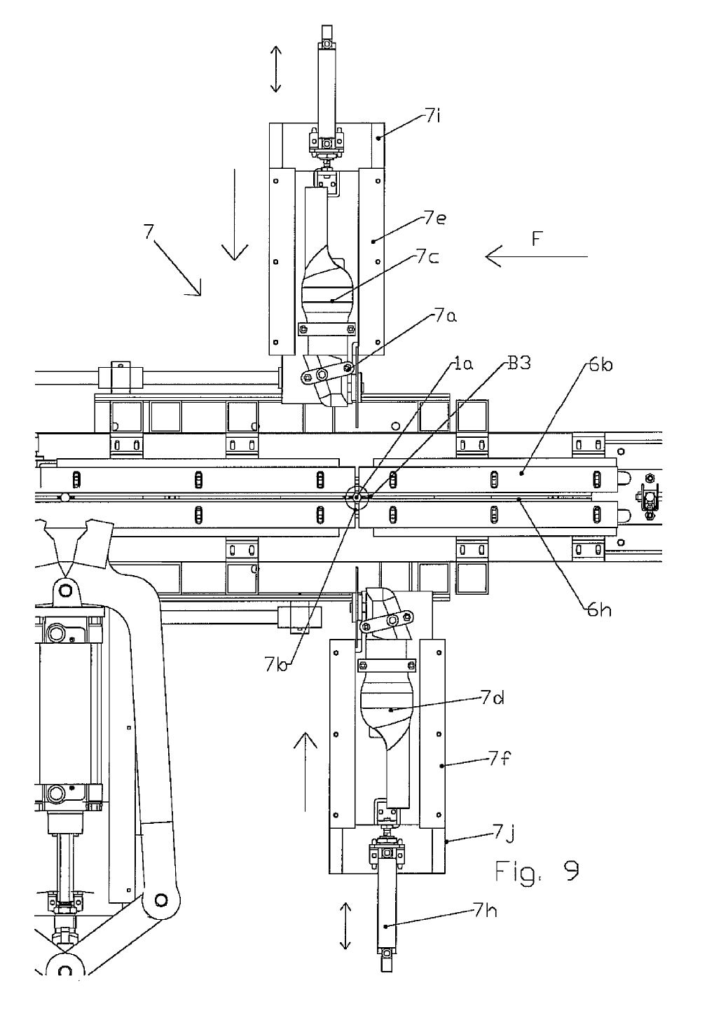

Thus, when the supervising software has defined, by virtue of the information issuing from the identification stations situated upstream, that the container B3 (only the neck of which appears in FIGS. 9 and 10) situated at the station 7 is liable to be provided with a collar, the motors 7c and 7d are triggered and, under the action of the rams 7g and 7h, the rotating saw blades are brought close to the neck as illustrated on the drawing in FIG. 10 until they come to saw it. The travel of the saws is of course calculated so that the blades 7a and 7b do not come into contact with the rod 1a. In order not to constitute an obstacle to the movement and action of the saws, the upper ramp on which the top end of the container is in abutment is preformed with a transverse notch 6g allowing passage of the circular blades. Given that the material of the containers is intended to be recycled, the neck of the container B3 being passed over by the blades does not constitute a drawback and guarantees the complete cutting of the collar. Once the cutting is performed, the carriage is returned to the initial position.

As illustrated on the drawing in FIG. 8, in order to keep the container B3 in position on the rod 1a, the station 7 is advantageously equipped with a removable support device 7k. In addition, the rod 1a is also held in position despite its articulation by the edges of the longitudinal passage 6h provided in the upper ramp 6b. These means of holding in position are necessary since the processing stations provide operations requiring contact with the container.

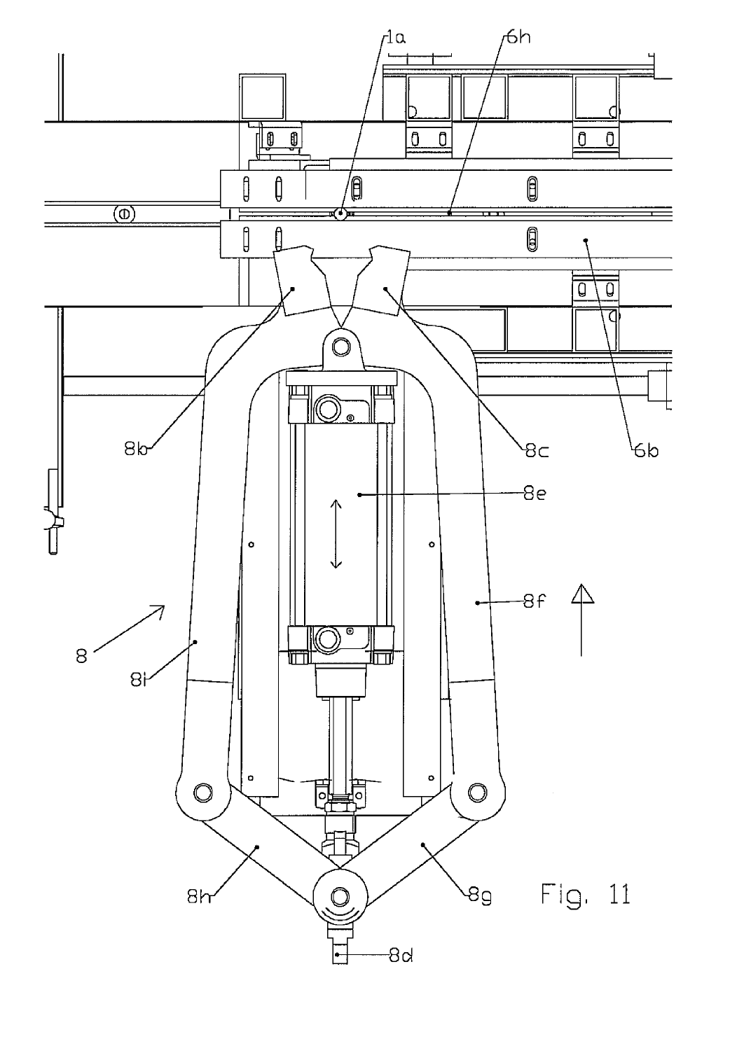

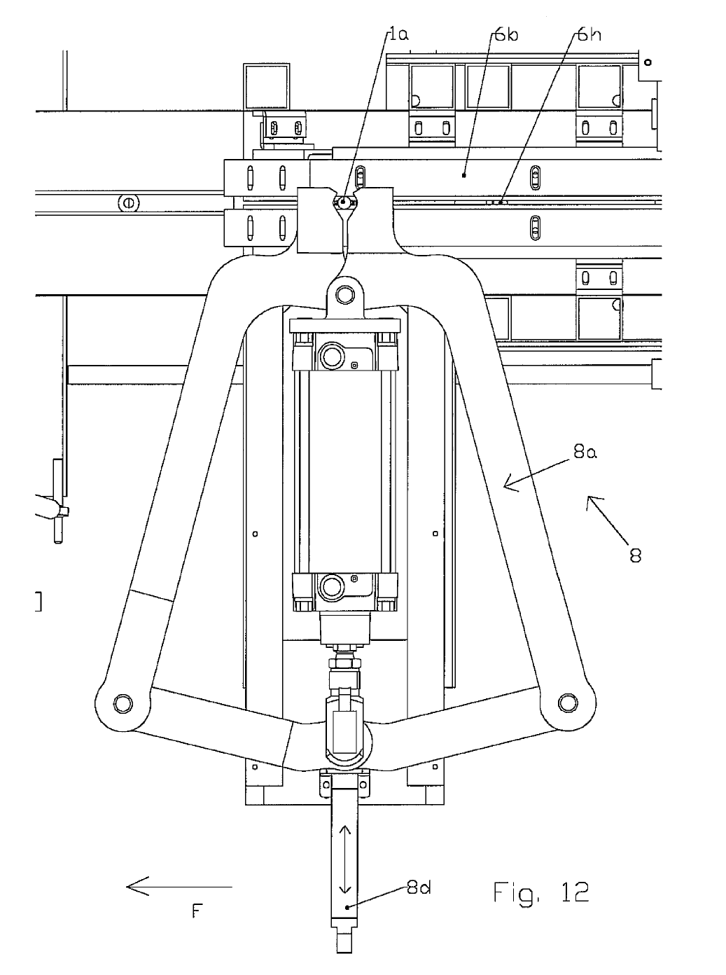

As illustrated on the drawings in FIGS. 1, 2, 8, 11 and 12, the station cutting the neck 8 is formed by a clamp 8a, the jaws 8b and 8c of which come to grip the neck, not illustrated, until it is crushed. This clamp 8a is illustrated in the standby position in FIG. 11 and in the active position in FIG. 12. As illustrated, a translation movement implemented by the ram 8d will bring the jaws 8b and 8c level with the neck of the container brought by the rod 1a and supported by the upper ramp 6b and then the movement of the ram 8e will make said jaws close around the neck as illustrated in FIG. 12, acting on the articulated arms 8f, 8g, 8h and 8i. Crushing the neck is preferable to cutting in order to avoid any projection. As illustrated, the travel of the jaws stops before the latter come into contact with the rod 1a. Once the neck has been crushed, the jaws separate from the rod 1a and the clamp 8a moves away from the movement path of the containers.

As for the collar cutting station, in order to hold the container in position on the rod 1a, the station 8 is advantageously equipped with a removable support device 8j. In addition, the rod 1a is also held in position despite its articulation by the edges of the longitudinal passage 6h provided in the upper ramp 6b.

According to a preferential embodiment, the jaws of the clamp are particularly wide in order to guarantee crushing of the neck. The sorting method of the invention consists of breaking the necks of the glass bottles identified as bottles equipped with a covering.

Once the cutting station 7 has been passed, the upper ramp 6b is interrupted and the container B returns in abutment on the rod 1a by means of its bottom.

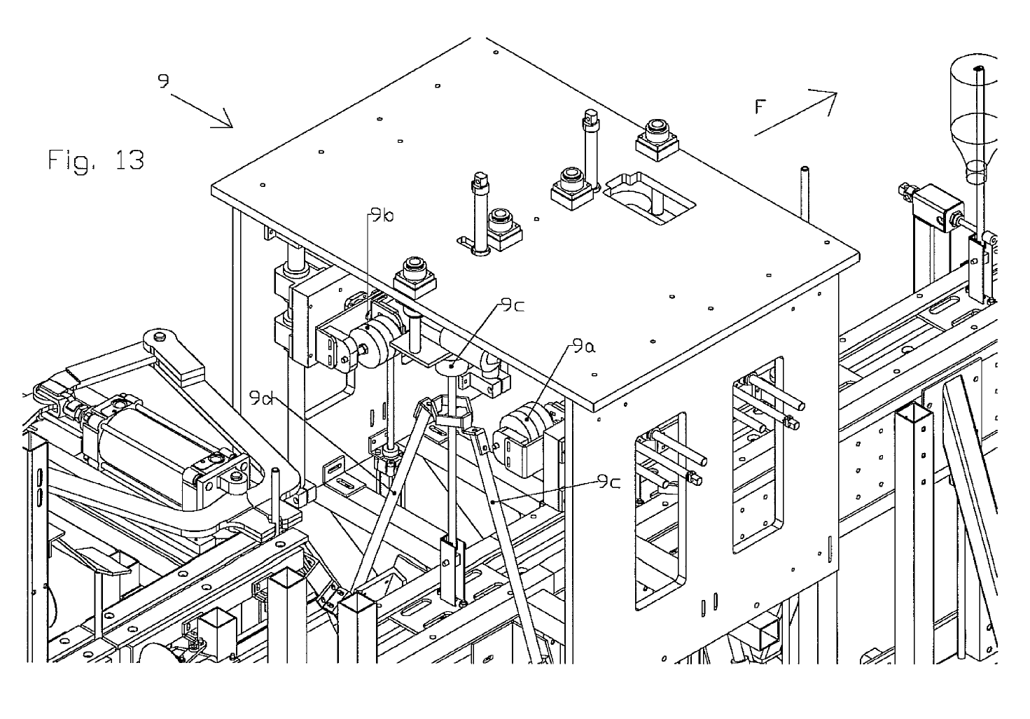

As illustrated on the drawing in the FIGS. 1, 2, 8, 13 and 14, the cleaning station 9 implements at least one and here two rotary brushes 9a and 9b along the walls of the containers, not illustrated, installed on the rods 1a. According to the embodiment illustrated, the brushing station is duplicated.

As illustrated, in order to keep the container B in position during this operation, several means are implemented. Lower telescopic arms 9c and 9d, once the support module 1 is positioned, come to bear on the wall of the container, not illustrated. A bottom support 9e also comes in the same movement to hold the bottom of the container B and make it turn in abutment on the rod 1a. This brushing operation will not only serve to remove any label from the container but also to guarantee the discharge of any collar and neck not completely disconnected from the container B.

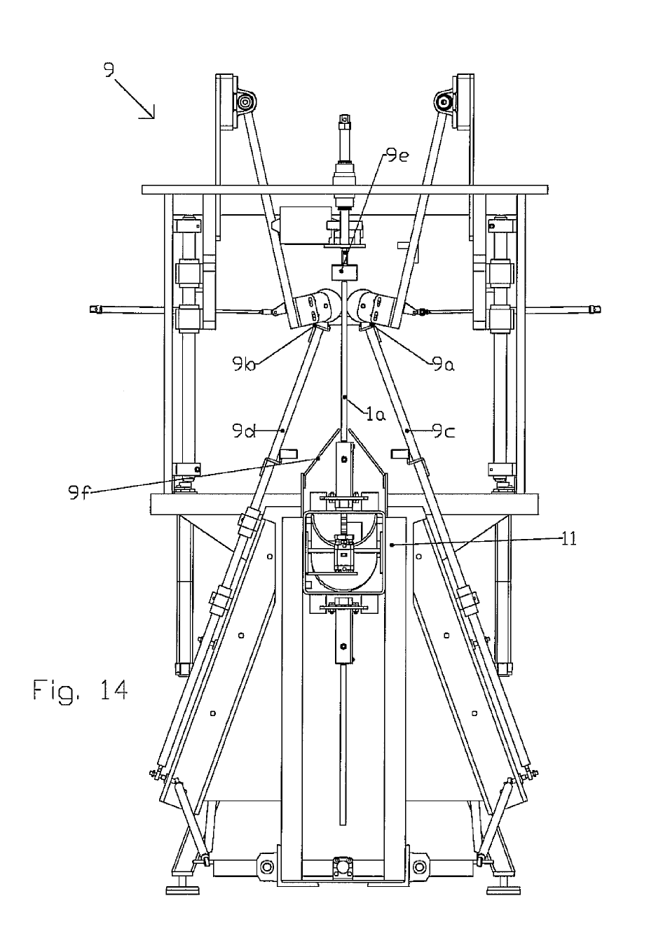

As illustrated on the drawing in FIG. 14, a cowling 9f protects the flexible link, not illustrated, moving in the chassis 11 from material projected by the operation. The lips of this cowling will also make it possible to hold the rod 1a in position during the brushing operation despite its articulation.

This articulation is used at the last station 10 of the device of the invention. As illustrated on the drawings in FIGS. 1, 2, 8 and 15, this last station 10, the function of which is to make the containers identified and processed drop into the hoppers 10a, 10b or to other devices dedicated to their shape or material, is formed by a plurality of tilting stations 10c associated here with a plurality of hoppers 10a, 10b, etc. Each tilting station 10c consists of a pusher ram 10d that will, by virtue of its emerging rod 10e, when the supervising system gives the instruction to do so, make the rod 1a pass from a vertical position to an inclined position (cf FIG. 3c) in which the container will slide towards the appropriate hopper.

Once the tilted rod has arrived at the end of the device C, the latter passes under the chassis 11 in order to be returned, still stepwise, to the reception zone 2. A runner of adapted shape 11c associated with said chassis puts the rod 1a vertically upright again in its spring 1f.

It will be understood that the device and method that have just been described above and depicted have been so with a view to a disclosure rather than a limitation. Naturally various arrangements, modifications and improvements can be made to the above example without for all that departing from the scope of the invention.

1. Device for sorting containers and packaging with volumes and made from materials that are liable to be different, characterised in that it is formed by a plurality of identification stations and/or a plurality of processing stations, and by a plurality of container support modules each formed by a rod on which a container is engaged through its opening, making the bottom of the container come into abutment on the top end of the rod, said support modules moving each container between and to the various stations.

2. Device according to claim 1, characterised in that each rod is associated with a plate serving as a guide means and a means of setting in movement.

3. Device according to claim 1, characterised in that each rod is associated in an articulated fashion with its plate so as to pass from a position in which the container is carried by the rod to a position in which the container slides along the rod.

4. Device according to claim 1, characterised in that said means of setting in movement is formed by a flexible link on which the support modules are disposed at regular intervals so that the movement of the containers takes place stepwise.

5. Device according to claim 4, characterised in that the flexible link is set in motion and guided on a chassis disposed so that the flexible link is continuous and the support modules, having arrived at one end of the chassis, can return to the other end.

6. Device according to claim 1, characterised in that it is equipped with a zone for receiving the containers which, situated at one end of the device, is formed by a partitioned space directly giving access to the support modules and is equipped with a work surface on which the user will put the containers before placing them on the rods.

7. Device according to claim 1, characterised in that it is equipped with a station for visual recognition of the container by video means determining the shape, colour and/or transparency.

8. Device according to claim 1, characterised in that it comprises a station for identifying the composition of the container comprising a spectrometer.

9. Device according to claim 8, characterised in that the spectrometer is fixed to a beam positioning it above the movement path of the containers for analysis of the bottom of the latter.

10. Device according to claim 1, characterised in that it comprises a station for differentiating the metals using an inductive sensor.

11. Device according to claim 1, characterised in that it comprises a station for measuring the weight of the container.

12. Device according to claim 11, characterised by the fact that the weight measurement station comprises, before the position where the container is weighed, an ascending ramp disposed on each side of the movement path of the support modules so as to allow only the diameter of the rod to pass so that, during the translation movement of the support module driven by the flexible link, the container comes into abutment on the ramp and performs an upward translation movement, this ramp bringing the top end of the majority of the containers to the same height, preventing the bottom of the latter from being in contact with the top end of the rod.

13. Device according to claim 12, characterised in that the movement of the support module and the inclination of the ramp bring the top end of the container level with an upper horizontal ramp, a portion which is independent of the rest of the ramp, the support module stops so that the container is positioned on this ramp portion, which is advantageously connected to a bracket secured to a weight measurement means, this bracket supporting the ramp portion being mounted mobile and moved in translation so that the latter is moved in an upward translation movement so that the weight measurement performed by the weight measurement means is not interfered with by the abutment of the rod.

14. Device according to claim 1, characterised in that it comprises a station for cutting the plastic collar on the containers.

15. Device according to claim 14, characterised in that the collar cutting station is formed by the blade of a saw that comes to be applied vertically to the neck of the container and on a travel sufficient to cut said collar.

16. Device according to claim 15, characterised in that the cutting station implements two independent circular saw blades rotating in the same vertical plane and providing a translational travel towards the neck of the bottle, each blade being set in motion by a motor each secured to a movable carriage providing their guidance in translation on an axis perpendicular to the axis on which the containers are set in motion in the direction of the arrow.

17. Device according to claim 1, characterised in that it comprises a station for cutting the neck of the container.

18. Device according to claim 17, characterised in that the neck cutting station is formed by a clamp, the jaws of which will come to grip the neck until it is crushed.

19. Device according to claim 18, characterised in that a translation movement implemented by a ram will bring the open jaws level with the neck of the container brought by the rod and then the movement of another ram will make said jaws close around the neck.

20. Device according to claim 1, characterised in that it comprises a station for cleaning the external surface of the container.

21. Device according to claim 20, characterised in that the cleaning station implements a rotary brush along the walls of the containers installed on the rods.

22. Device according to claim 21, characterised in that the cleaning station comprises lower telescopic arms that, once the support module is positioned, come to bear on the wall of the container, and a bottom support coming in the same movement to hold and turn the bottom of the container in abutment on the rod.

23. Device according to claim 1, characterised in that it comprises a discharge station dropping the container into hoppers dedicated to the container identified.

24. Device according to claim 23, characterised in that discharge station is formed by a plurality of tilting stations associated here with a plurality of hoppers.

25. Device according to claim 24, characterised in that each tilting station includes a pusher ram that will, by virtue of its emerging rod, make the rod pass from a vertical position to an inclined position in which the container will slide towards the appropriate hopper.

26. Method of sorting containers and packaging with volumes and materials liable to be different, characterised in that it includes making the container pass through a plurality of identification steps before performing processing operations and sorting operations properly speaking, a plurality of container support modules moving each container between and to the various steps.

27. Method of sorting containers and packaging with volumes and materials liable to be different using the device formed according to claim 1 by means of a plurality of identification stations and/or a plurality of processing stations, and by a plurality of container support modules each including a rod on which a container is engaged by its opening, said support modules moving each container between and to the various stations, characterised in that it includes visually noting the presence of the rod in the container in order to determine the transparency of said container.

28. Method of sorting containers according to claim 26, characterised in that it includes removing the plastic collar from the bottles noted as equipped with such a collar.

29. Method of sorting containers according to claim 26, characterised in that it includes breaking the neck of the glass bottle identified as a bottle equipped with a covering.
